(19) United States
(12) Patent Application Publication
(10) Pub. No.: US 2009/0129595 A1
(43) Pub. Date: May 21, 2009

(54) Verification of a product identifier

(76) Inventor: Jouni Stam, Helsinki (FI)

Correspondence Address: SQUIRE, SANDERS & DEMPSEY L.L.P., 8000 TOWERS CRESCENT DRIVE, 14TH FLOOR, VIENNA, VA, 22182-6212, US

(21) Appl. No.: 11/921,899

(22) PCT Filed: Jun. 9, 2006
(86) PCT No.: PCT/FI2006/000186

§ 371 Date: Jan. 8, 2009

(30) Foreign Application Priority Data
Jun. 10, 2005 (FI) 20050622

(51) Int. Cl. H04L 9/00

(52) U.S. Cl. 380/277

(57) ABSTRACT

A system and method for enabling the verification of the authenticity of a product identification circuit, wherein the checking is based on an encryption key (11) stored to the product identification circuit (10). The encryption key has been stored to the product identification circuit so that one cannot read it from outside the circuit. In addition, there is in the circuit a public memory (13) that can be read from outside the circuit. Arranged on the product identification circuit are data processing means (12) that are capable of computing a check sum (16) based on the information contained in the circuit. To compute the check sum, the encryption key stored to the circuit is used. A corresponding key has also been stored to the database of the central system (19). In checking, the product identification circuit is read by the reader (18). The check sum of the product identification circuit and the public information used for the computation thereof are transmitted to the central system, which computes the corresponding check sum and compares it with the check sum received from the product identification circuit. In case the sum matches, the information contained in the identifier is original.

### FIELD OF THE INVENTION

The invention relates to the identification of products and their origin, as well as to the identification of other product information, and also to tracking of the movement of goods during the life cycle of a product.

### BACKGROUND OF THE INVENTION

With the advancement of information systems of shops, information on most products has been stored to information networks either for the shop's internal use or public use. Information systems are typically used for stock follow-up, pricing, transmitting additional information associated with the products, and for other similar functions. Previously, the product identifier, usually functioning as the key in the systems, has been read by a bar code reader. The readers have, however, the disadvantage of readability of the information as well as the limited capacity of a bar code.

Due to this, electronically remote-readable product identifiers, so-called RFID product identifiers, have been developed. In these, typically an induction current is used to cause the sending of the product information to a near-by reader of the product identifier via radio path. There are various kinds of readers and they vary according to the purpose of use. These product identifiers can be used, for example, for product follow-up, reading the price information, or even as burglar alarms. Typically, a product identifier has been placed on the product as a tag and contains a small amount of information that can be modified at least partly. The product identifier circuit can also contain a small-sized processor for processing information. The processor can be so manufactured that it only performs a given task. With the advancement of circuit technology, more and more components can be placed within a compact space, and the functionality of the future tags will be enhanced significantly.

With increasing amounts of information, the dependability of the information contained in a tag may become a problem. The information contained in the tags shall be verifiable and hard to tamper with. Due to a large stock of hardware, this improved product identifier circuit placed on a tag shall also be compatible with the present devices.

### OBJECTIVE OF THE INVENTION

It is an objective of the invention to disclose a method and system for checking the authenticity of a product identifier circuit.

### SUMMARY OF THE INVENTION

The present invention concerns a product identification circuit for storing product information, the circuit comprising a memory for storing the product information, as well as a telecommunication connection for transmitting the product information to the reader. The memory for storing the product information comprises a public memory for storing the publicly readable information contained in the product identification circuit, and a device-specific memory for storing the encryption key. In addition, the product identification circuit comprises processing means, e.g. a processor, for reading the device-specific memory of the product identification circuit. The processing means have further been arranged to compute a check sum based on the encryption key of the device-specific memory and on the information contained in the public memory. The device-specific memory of the product identification circuit can only be read using the processing means of the circuit's own. The telecommunication means can also be used to receive information to be processed by the processing means. Further, the invention concerns a method and system for using the aforementioned circuit.

The method is used to check the authenticity of the aforementioned product identification circuit. Before using the method, the necessary encryption key shall be stored to both the product identifier circuit being checked and the central system. The invention operates with the symmetric secret key method, but in one embodiment of the invention, public key cryptography is used, whereby the secret encryption key is stored to the product identification circuit, and the public encryption key corresponding to the secret key is stored to the central system. In the method, the secret key stored to the product identification circuit is read by the processing means of the product identification circuit; the public information stored to the product identification circuit is read by the processing means of the product identification circuit; a first check sum is computed based on the aforementioned information which was read; the first check sum and the aforementioned public information which was read are transmitted to the reader; the first check sum and the aforementioned public information which was read are transmitted from the reader to the central system; a second check sum is computed based on the aforementioned public information which was read and the encryption key stored to the central system; and the first and second check sum are compared with one another to verify the authenticity of the information contained in the product identifier circuit. In one embodiment of the invention, prior to the verification, a random number is generated, which is transmitted to the product identifier circuit to be used in the computation of the check sum.

The system for verifying a product identification circuit comprises a telecommunication connection for transmitting the information contained in the product identification circuit to the reader; a reader for reading the information contained in the product identification circuit and for transmitting it further; a product identification circuit and a central system for receiving and processing the information transmitted by the reader. In one embodiment of the invention, the reader further comprises a random number generator for generating a random number.

The advantages of the invention described above include enabling checking of the authenticity of the circuit, improving the dependability of additional information fields, as well as simplicity and compatibility with previous systems. The system of the present invention enables dependable identification of the circuits being used. The accuracy of the dependability can be adjusted by choosing the method to be used for the computation of the check sum according to the required dependability. The present invention uses a dependable algorithm also for the verification of the authenticity of the information stored to the product identification circuit. The present method has the advantage of being simple. As it is possible to use the method of the secret key in the system, the computation efficiency required of the product identifier circuit is lesser. Due to this, besides being simple, the invention provides the additional advantage of being inexpensive in use, which is an essential factor in using product identifier circuits. The cheaper a circuit can be made, the cheaper products it can be placed within without significantly increasing the costs. Alternatively, it is possible to use the encryption method of the public key, whereby the resulting system requires more computation efficiency and is thus more expensive, but is, in turn, better in respect of key security because the secret key is only stored to the circuit from where it cannot be read. Further, the invention has the advantage that it enables reading of the product identifier using devices that cannot compute a check sum. In that case, the product identifier circuit of the invention functions in the same manner as a conventional circuit and enables reading of the product information, although one could not utilise all the features associated with the product identification circuit of the invention.

### LIST OF FIGURES

FIG. 1 illustrates one system of the invention; and

FIG. 2 illustrates one method of the invention.

### DETAILED DESCRIPTION OF THE INVENTION

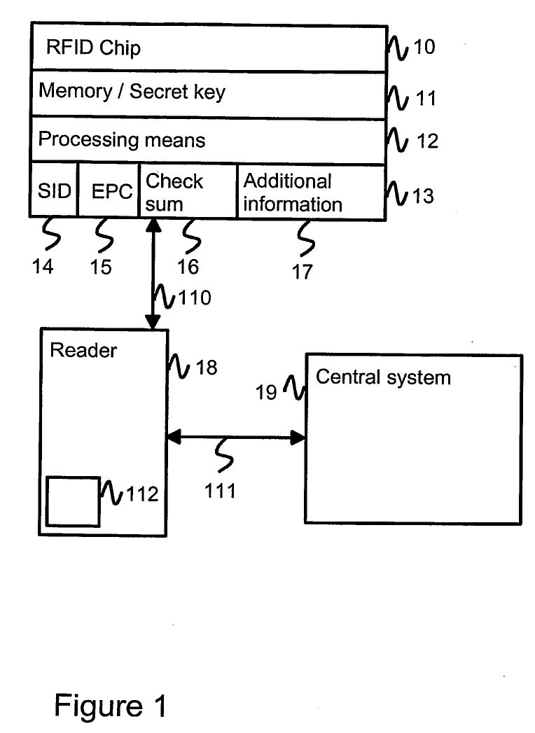

FIG. 1 illustrates one system of the invention. The system comprises a remote-readable product identifier circuit 10, a reader 18 and a central system 19. The product identifier circuit 10 of the present invention is a product identifier circuit attached to a product that comprises information about the product, which information can be read using a reader. Preferably, the product identifier circuit is an RFID circuit, but the remote-readable product identifier circuit can be any prior-art product identifier circuit provided with data processing means 12. The data processing means include e.g. a small-sized specialised processor or the like. These means shall be able to perform simple computations and to read from the memory, or one shall also be able to add to them information that is readable in some other manner. Similarly, the reader of the product identifier circuit can be any prior-art reader as long as it is provided with telecommunication connections 111 and can be arranged to perform functions that are essential from the standpoint of the invention. In case a specific reader is used with the invention, the telecommunication connection preferably is a wireless, generally used telecommunication connection. It must, however, be noted that the reader can also be a reader attachable to a computer or one fixedly arranged in conjunction with the computer, making a wireless network unnecessary. In FIG. 1, a reader 18 is used to mean a reader assembly that can include either a separate reader, a combination of a simple reader and a computer, or other similar device or hardware assembly.

As concerns the present invention, substantial is the fact that the secret key stored 11 to the memory has been so stored that it can be only read by the processing means 12 arranged in connection with the product identifier circuit. Typically, this is arranged so that the RFID circuit 10 comprises both a memory 11 and means 12 on the same circuit so that the memory 11 cannot be read from outside the circuit. The RFID circuit 10 has been connected to the outside world in a wireless manner by a connection 110 and is provided with a specific public memory reading area 13, enabling one to read information using a reader 18. The connection 110 can be e.g. a radio frequency connection operating with induction current. This reading area 13 includes e.g. the ID number 14 of the circuit, an electronic product code 15, a generated check sum 16 and additional information 17. The ID number 14 of the circuit is a typical field, but it is mainly designed to provide information on the circuit manufacturer, and it is not necessary for the present invention. The number of fields can be varied according to need, but at its minimum, the reading area 13 shall comprise at least the check sum and some kind of identification information, most preferably an electronic product code 15. The fields can be varying or permanent in content. The number of fields is limited by the amount of memory placed on the circuit, and their number can be increased according to need within the limits of the amount of memory. The information contained in the reading area 13 can also be read by the processing means 12. The reader 18 is used to read in the circuit the check sum 16 and the other information 13 contained in the reading area and used for the computation of the check sum. The information which was read is transmitted to the central system 19, having the secret keys of all the circuits stored therein. This has been arranged, for example, so that the circuit manufacturer generates a secret key for every circuit manufactured by it. Based on the information transmitted, the central system computes its own check sum and compares it with the transmitted check sum. In case the sums are matching, the authenticity of the product identifier circuit is verified.

As concerns the present invention, most substantial is comprehension of how the check sum is computed and checked, which is explained in the following example. The check sum to be computed can be any known check sum or a hash function, e.g. MD5. These are obvious to a person skilled in the art, so they are not explained in more detail herein. We select, for example, a product and provide it with a remote-readable piece of information, e.g. an RFID circuit, fixedly attached to the product. In the case of the present example, the ID number granted by the circuit manufacturer serves as the circuit identifier information and the ID number 14. In addition to this, as the identification information one can also use e.g. the EPC information 15 granted by the product manufacturer and an additional information field 17, but these are not necessary. Thereafter, the check sum of the circuit is computed based on the information used and the secret key 11 stored to the circuit. Correspondingly, when checking, the reader 18 is used to read in the circuit all the information used for the computation of the check sum, except for the secret key, as well the check sum computed when reading using the reader, and this information is transmitted to the central system, containing the previously stored secret keys corresponding to the ID numbers. The system retrieves, based on the ID number, the secret key and computes its own check sum based on the information transmitted, and compares it with the transmitted check sum. In case the check sum matches, the circuit has been dependably identified, and the ID number of the circuit can be used for tracking the product in the database of the manufacturer of the RFID circuit, which database may also contain information on whom the circuit has been granted to. Alternatively, a product identifier can serve as the key, whereby the search for retrieving the information is performed in the database of the product manufacturer, importer or distributor.

In addition to a basic application, the circuit of the invention can be utilised with several different additional applications. The additional information in the above example can also be stored to the central system, making it unnecessary to transmit further all the information contained in the reading area, or the central system ignores those fields that have been stored to the memory of the system. In this manner, for example, the name of the owner of the object can be stored to the additional information field. When the information associated with the object is read by means of a reader, the reader displays the information which was read, including the owner of the object. Thereafter, a checking inquiry as shown in the previous example is made, but besides the secret key, also the registered owner of the object is retrieved from the information contained in the central system. Thereafter, a check sum is computed from the information of the central system's own and from that transmitted thereto, and the check sum is compared with the check sum which was read in the RFIF circuit. In case there has been a change in the additional information field without registering it, e.g. without authorisation, the check sum which was read and the check sum which was computed do not match. In a similar manner, also other fields to be checked can be stored to the central system.

The present invention is characterised by the fact that the product identifier circuit being used, e.g. an RFIFD circuit, computes a check sum each reading time, enabling one to include within the check sum information that has possibly changed in the circuit. Because the check sum is disposed in a public reading area, it is substantially harder to tamper with, in case the sum is computed when reading before transmitting the information to the reader. In order that the reader can with certainty make sure of the fact that the product identifier circuit truly computes a check sum, it generates a random number, which is transmitted to the product identifier circuit and to the central system. To enable this, there is in the reader a random number generator 112 or means for receiving a random number from the central system. The random number is used as one basis for the check sum. In case the circuit does not use the random number when computing the check sum, but the central system is using, the check sums do not match. By this one can judge that the circuit does not either work or its information has been changed, and one cannot trust on its authenticity.

In addition to the identification described above, it is also possible to add to the central systems other functions such as transmitting product information and logistics information such as tracking of products. Thus, it is obvious to a person skilled in the art that a central system is used to mean a larger complex having as one feature the verification of the authenticity of the product identification circuit that is substantial with regard to the invention.

In one embodiment of the invention, the encryption method of the public key is used for the generation and checking of the check sum. In the method, a secret key is stored to the product identifier circuit in the same manner as in the secret key method described above. The pubic key corresponding to the secret key is stored to the central system. The product identifier circuit computes the check sum using the selected method and encrypts it using its secret key. Thereafter, all the information is transmitted to the central system in the same manner as in the example of the secret key described above. Thereafter, the central system computes its own check sum, decrypts the encryption of the check sum transmitted by the product identifier using its public key and compares the check sums with one another. In case the sums are matching, the product identifier circuit is authentic. In this manner, the key security of the central system is improved because the key of the central system can be only used to decrypt the encryption of the check sum and thus to check the check sum of the product identifier circuit. Compared to the secret key method, this method has the disadvantage of an increased need for computation as well as an increase in the length of the keys, so it is more poorly suited for cheap mass products than the symmetric method.

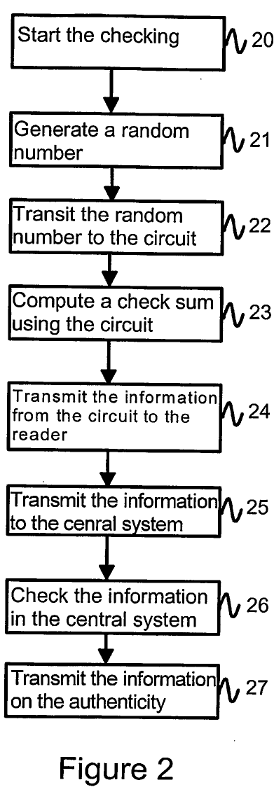

FIG. 2 illustrates one advantageous implementation of the utilisation of the method of the invention for verifying the authenticity of a product circuit. The verification is started e.g. by selecting on the verification device, step 20. After indication of the verification, the verification device generates a check sum to enable verification of the operation of the circuit, step 21. This step is not obligatory, in case one trusts on the operation of the circuit, or in case this verification is not considered substantial. In case a random number is generated, it is transmitted to the product identifier circuit, step 22. Thereafter, the circuit computes a check sum utilising the secret key stored to the circuit, the random number and the public information stored to the circuit, step 23. Public information includes e.g. the ID number of the circuit. The check sum computed by the circuit and the information required for its computation are transmitted back to the central system, step 24. The reader transmits the information further to the central system, step 25. If the random number was computed at step 21, then it is also transmitted. The central system retrieves from its database the secret key e.g. based on the ID number of the circuit. Thereafter, it computes the check sum using the secret key and the information received by it. In case the check sum corresponds to the check sum computed by the circuit, the circuit is authentic, step 26. Finally, the information about the authenticity is transmitted to the verification device and is displayed to the user, step 27.

The invention is not limited merely to the examples of its embodiments referred to above; instead many variations are possible within the scope of the inventive idea defined by the claims.

1. A system for the checking the authenticity of a product identifier circuit, the system comprising:
a product identification circuit (10) comprising a telecommunication connection (110) for transmitting the information contained in the product identification circuit to a reader (18);
a reader (18) for reading the information contained in the product identification circuit (10) from the reader and for transmitting it further;
a central system (19) for receiving the information transmitted by the reader,
characterized in that the product identification circuit (10) comprises a public memory (13) for storing the publicly-readable information contained in the product identification circuit, and a device-specific memory (11) for storing the encryption key, wherein for reading the device-specific memory of the product identification circuit, there are in the product identification circuit processing means (12), the processing means being further arranged to compute a check sum (16) based on the encryption key of the device-specific memory and the information contained in the public memory; and
the central system (19) further comprises the aforementioned encryption key for computing and checking the aforementioned check sum.

2. The system as defined in claim 1, characterized in that the encryption key stored to the device-specific memory (11) and to the central system (19) is a symmetric encryption key.

3. The system as defined in claim 1, characterized in that the encryption key stored to the device-specific memory (11) is a secret key and the encryption key stored to the central system (19) is a public key corresponding to the aforementioned secret key.

4. The system as defined in claim 1, characterized in that the telecommunication connection (110) of the product identification circuit is arranged to receive information to be processed using the processing means.

5. The system as defined in claim 2, characterized in that arranged in the reader is a random number generator (112) for sending a random number to the product identification circuit to be used in the computation of the check sum.

6. The system as defined in claim 1, characterized in that the public memory of the product identification circuit comprises at least two fields for storing the identification number of the product identification circuit and the check sum.

7. The system as defined in claim 6, characterized in that one or more fields of the public memory of the product identification circuit can determined to be constant or changing.

8. The system as defined in claim 1, characterized in that there is information of the public memory of the product identification circuit arranged in the central system.

9. The system as defined in claim 1, characterized in that the reader has been connected to the computer for processing the information and for transmitting it further.

10. A production identification circuit for storing product information, the circuit comprising a memory for storing the product information as well as a telecommunication connection for transmitting the product information to the reader, characterized in that the product identification circuit (10) further comprises:
a public memory (13) for storing the publicly readable information contained in the product identification circuit;
a device-specific (11) memory for storing the encryption key; and
processing means (12) for reading the device-specific memory of the product identification circuit, the processing means being further arranged to compute a check sum (16) based on the encryption key of the device-specific memory and the information contained in the public memory.

11. The product identification circuit as defined in claim 10, characterized in that the telecommunication connection (110) of the product identification circuit is arranged to receive information to be processed by the processing means.

12. The product identification circuit as defined in claim 10, characterized in that the device-specific memory can only be read by the processing means of the product identification circuit.

13. A method for checking the authenticity of a product identification circuit, characterized in that the method comprises the steps of:
reading the secret key stored to the product identification circuit by the processing means of the product identification circuit;
reading the public information stored to the product identification circuit by the processing means of the product identification circuit;
computing a first check sum based on the aforementioned information which was read;
transmitting the first check sum and the aforementioned public information which was read to the reader;
transmitting the first check sum and the aforementioned public information which was read from the reader to the central system;
computing a second check sum based on the aforementioned public information which was read and the encryption key stored to the central system; and
comparing the first and the second check sum with one another to verify the authenticity of the information contained in the product identification circuit.

14. The method as defined in claim 13, characterized in that generating on the reader a random number that is transmitted to the product identification circuit and the central system to be used in the computation of the check sums.

15. The method as defined in claim 13, characterized in that storing the secret key to the product identification circuit and the central system prior to reading by means of the processing means of the product identification circuit.

16. The method as defined in claim 13, characterized in that computing the first check sum using the secret key of the asymmetric encryption method and computing the second check sum using the public key of the asymmetric encryption method.
